(19) United States
(12) Patent Application Publication
(10) Pub. No.: US 2018/0162475 A1
(43) Pub. Date: Jun. 14, 2018

(54) CYCLING RECORD SYSTEM

(71) Applicant: EGREEN TECHNOLOGY INC., HSINCHU CITY (TW)

(72) Inventor: SHENG YU PENG, HSINCHU CITY (TW)

(21) Appl. No.: 15/375,220

(22) Filed: Dec. 12, 2016

(51) Int. Cl. B62J 99/00; B62K 3/00; B62M 6/40

(52) U.S. Cl. CPC B62J 99/00; B62K 3/00; B62M 6/40; B62J 2099/0026; B62J 2099/0013; B62J 2099/002; B62J 2099/004; B60L 2200/12

(57) ABSTRACT

A cycling record system includes a hub generator; a power harvesting module; a memory device; a processor; a battery module; and a wireless transmission module; wherein, the hub generator is installed within a hub of a bicycle wheel, the processor is coupled electrically with the hub generator, the battery module is coupled electrically with the memory device and the wireless transmission module for supplying power thereto; wherein, the power harvesting module is coupled electrically with the hub generator and the battery module such that the power harvesting module rectifies and boosts a voltage generated by the hub generator in order to recharge the battery module continuously, thereby permanently allowing the processor to process signals continuously from the hub generator and converting into data to write the data in the memory device or transmitting the data outbound via the wireless transmission module.

### BACKGROUND OF THE INVENTION

The present invention relates generally to a cycling record system, and more particularly to a cycling record system for bicycles, in which power is supplied automatically and continuously such that storing of data (like driving records) and transmission of data is conducted permanently.

### BACKGROUND ART DISCUSSION

In recent years, cycling is not only a means of transport, but also becomes a fitness or leisure and entertainment tool and during the cycling riding all of interesting things or places are recorded for memory and hence recording the past is the trend of our lives. Although some electronic gadgets are available and are adapted to be installed on bicycles for recording the road status, but they require power is supplied from an external power source so that the bicycle is installed with exposed battery modules and wires, etc., thereby affecting the appearance and more security concerns.

The Internet of Things (IoT) is an information carrier of the Internet and traditional telecom networks. It allows all the ordinary objects that can perform independent functions to interwork with each other. Under this framework, there are many performance of objects controlled and operated by cell phones from a remote distance. Bicycle is an outdoor transportation means. Waterproof and dustproof design is more important and the structure of Internet of Things is applied to study how to simplify the structure of cycling record system that is easy to install on the bike, that can record or transmit the cycling status continuously and that can be manufactured at low cost with little failure.

### SUMMARY OF THE INVENTION

A primary objective of the present invention is to provide a cycling record system for bicycles, in which power is supplied automatically and continuously such that data (like driving records) recording is conducted permanently or transmission of data to a cell phone or an information carrier.

Another objective of the present invention to provide a cycling record system for bicycles, which includes an inertial sensor unit, a GPS module such that a position coordinates of the bicycle can be obtained or the position of the bicycle can be monitored from a remote place. In addition, owing to present of an electric lock, the bicycle provided with the cycling record system of the present invention when stolen can be locked by the electric lock by the owner from a remote place.

A cycling record system for a bicycle according to the present invention includes: a hub generator; an electrical power harvesting module; a memory device; a processor; a battery module; and a wireless transmission module; wherein, the hub generator is installed in a hub of a bicycle wheel, the processor is coupled electrically with the hub generator, the battery module is coupled electrically with the memory device and the wireless transmission module for supplying power thereto such that the process is capable of receiving and processing signals from the hub generator and converting into data consisting of speed rate and traveling distance of the bicycle so that the data can be recorded in the memory device or transmitted outbound via the wireless transmission module; wherein, the power harvesting module is coupled electrically with the hub generator and the battery module such that the power harvesting module rectifies and boosts a voltage generated by the hub generator in order to recharge the battery module continuously, thereby permanently allowing the processor to process the signals to write the data in the memory device or transmitting the data outbound.

In this embodiment of the present invention, the processor includes a Hall element for detecting a magnetic field and its intensity of the hub generator so as to obtain the speed rate and the traveling distance of the bicycle wheel. In another embodiment, the process processes and obtains the speed rate and the traveling distance of the bicycle wheel by means of detecting a voltage phase change in the magnetic field of the hub generator.

The cycling record system of the present invention further includes an inertial sensor unit and a GPS (Global Positioning System) module, wherein the inertial sensor unit consists of an accelerometer, a gyroscope and a magnetometer for enhancing a procession performance of the processor such that the processor obtains a position coordinates via the GPS module so the position coordinate can be stored within the memory device or transmitted outbound via the wireless transmission module. Under this condition, the rider can fully record one's own data including the bicycle riding speed rate, the traveling distance of the bicycle or the position coordinate of the bicycle for future exercising target or inference of his physical exercise during the riding performance.

The cycling record system of the present invention further includes an electric lock coupled electrically to the processor such that the power generated due to riding of the bicycle can be checked by pairing the wireless transmission module and a smart phone of the rider, whether the bicycle really belongs to the rider or the increased riding speed rate via the inertial sensor unit. Since the position coordinate of the bicycle can be monitored through the GPS module, the bicycle can be tracked easily if stolen, thereby facilitating in retrieving of the bicycle when provided with the cycling record system of the present invention.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram representing a cycling record system according to a first embodiment of the present invention;

FIG. 2 illustrates the cycling record system of the present invention installed in a bicycle;

FIG. 3 is a block diagram representing a cycling record system according to a second embodiment of the present invention;

FIG. 4 shows a smart phone or an information carrier illustrating cycling data according to the cycling record system of the present invention; and

FIG. 5 is a block diagram representing a cycling record system according to a third embodiment of the present invention.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

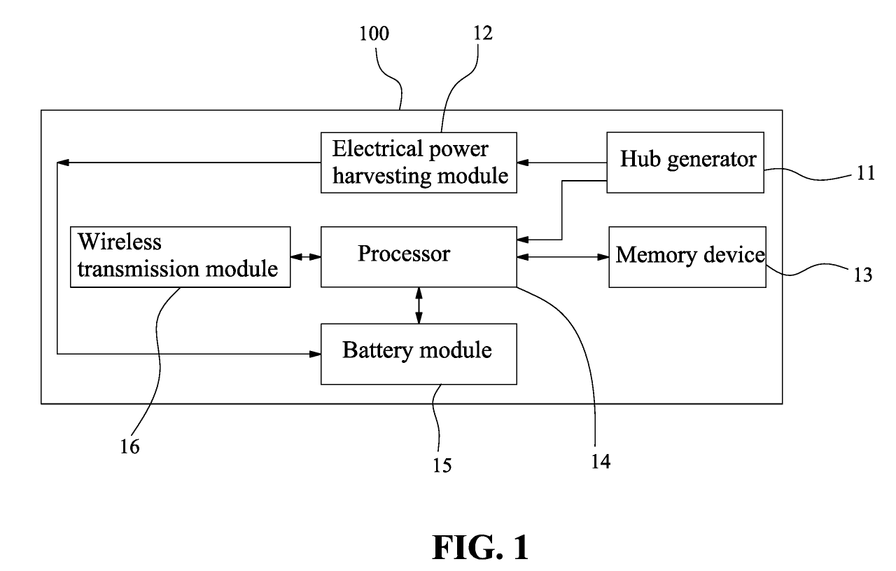

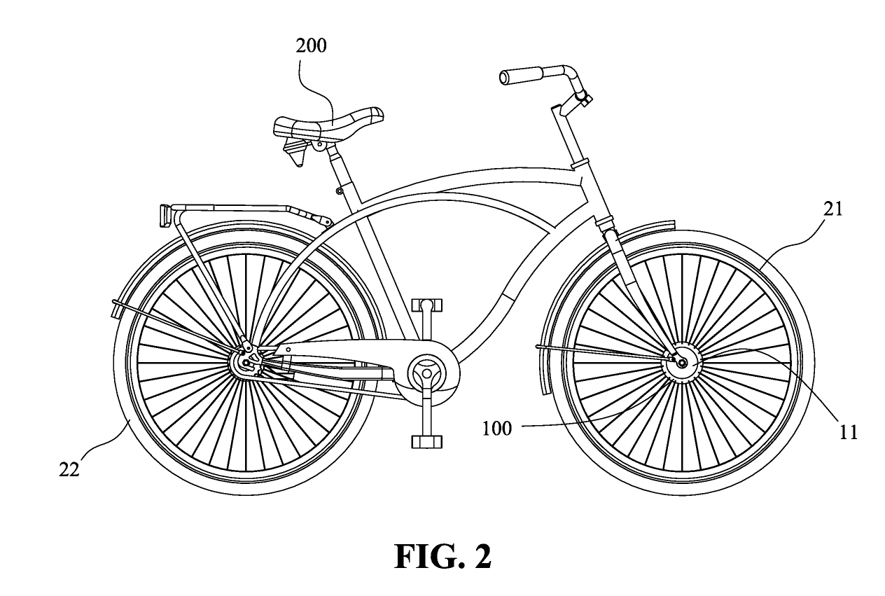

Referring to FIGS. 1 and 2, wherein FIG. 1 is a block diagram representing a cycling record system according to a first embodiment of the present invention and FIG. 2 illustrates the cycling record system of the present invention installed in a bicycle. As shown, the cycling record system 100 for a bicycle according to the present invention includes: a hub generator 11; an electrical power harvesting module 12; a memory device 13; a processor 14; a battery module 15; and a wireless transmission module 18.

Preferably, the hub generator 11 is installed in a hub of a bicycle wheel so that the hub generator 11 generates electrical power when the bicycle wheel is pedaled by a rider of the bicycle. In this embodiment, the hub generator 11 is installed within the hub of the front wheel 21, however the hub generator 11 can also be installed within the hub of the rear wheel 22. Two installation methods are implemented, firstly, the hub generator 11 is directly installed within the hub of the wheel or secondly the same is secured on the bicycle frame adjacent to and connected operably to the hub via a rotating part so as to be rotated simultaneously with the hub of the wheel. The hub generator 11 in this embodiment produces low voltage, such as microwat when the wheel is pedaled, thereby eliminating the rider to provide heavy burden and facilitating an ease riding of the bicycle. The generated power is mainly supplied to the processor for execution of the desired tasks so that the data can be transmitted outbound or written within the memory device. Under this condition, no high voltage or power is required which is generally used for lighting or the driving unit. In other words, the cycling record system of the present invention is simple in structure so that the hub generator can be integrated into the hub of the bicycle wheel and no connection wire will be exposed to an exterior of the bicycle frame.

The power harvesting module 12 is coupled electrically to the hub generator 11 and the battery module 15. The power harvesting module 12 includes at least one rectifying circuit for rectifying a charging circuit such that the voltage produced from the hub generator 11 is boosted so as to recharge the battery module 15. The battery module 15 is coupled electrically with the processor 14 and the wireless transmission module 18 for supplying power thereto.

The processor 14 is coupled electrically to the hub generator 11, the battery module 15, the memory device 13 and the wireless transmission module 16 such that the processor 14 is capable of receiving and processing signals from the hub generator 11 and converting into data consisting of speed rate and traveling distance of the bicycle so that the data can be recorded in the memory device 13 or transmitted outbound via the wireless transmission module 18. In this embodiment, a smart phone or an information carrier is used for receiving the data, by utilizing the software of the smart phone, the data are executed or adjusted and later are recorded. The processor 14 applies two methods, firstly, a Hall element (a magnetic element) detects a magnetic field and its intensity of the hub generator 11 so as to obtain the speed rate and the traveling distance of the bicycle; and secondly, the speed rate and the traveling distance of the bicycle are obtained by means of detecting a voltage phase change of the magnetic wave of the magnetic field of the hub generator 11.

According to the present invention, it is designed that during riding of the bicycle, the power generated from the hub generator 11 provides constant execution of the processor 14 such that the data (like number of rotation of the wheel and the traveling distance) are recorded or are transmitted outbound such that the data will be displayed over the smart phone or the information carrier so that the cycling record system of the present invention requires low power for operation. In addition, continuous rotation of the bicycle wheels can result the hub generator to produce the power constantly, however those features that required a relatively large amount of power are conducted by the external smart phone or the information carrier, the hub generator of the present invention can be integrated into the hub of the bicycle wheel, thus the cycling record system 100 of the present invention can be produced in a compact size.

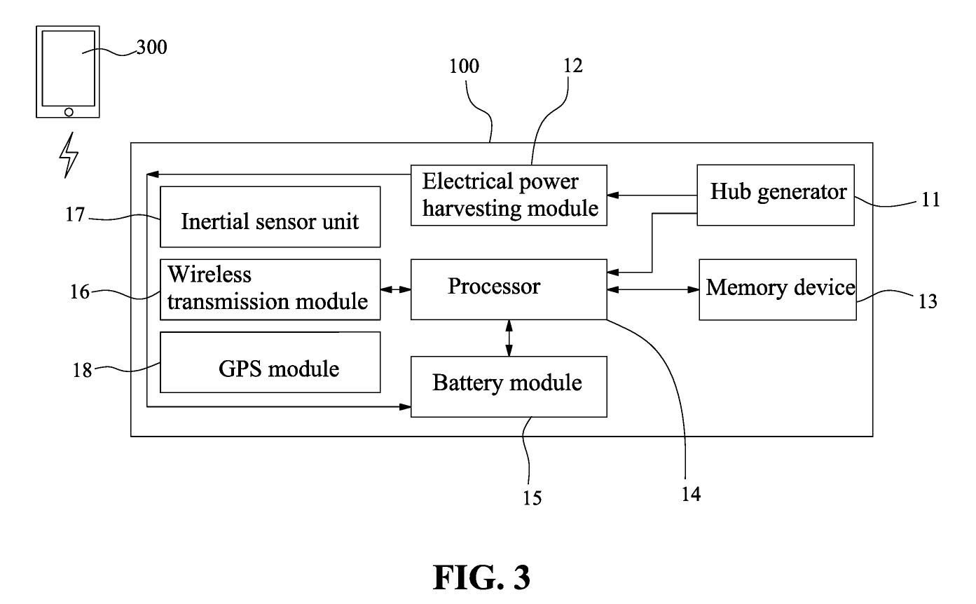

FIG. 3 is a block diagram representing a cycling record system according to a second embodiment of the present invention. The second embodiment further includes an inertial sensor unit 17 and a GPS module 18, which are coupled electrically to the processor 14. Preferably, the inertial sensor unit 17 consists of an accelerometer, a gyroscope and a magnetometer for enhancing the procession performance of the processor 14 such that the data can be transmitted outbound via the wireless transmission module 16. The accelerometer detects the three-dimensional Cartesian coordinates x, y, z of gravity acceleration while the gyroscope is to detect three-dimensional space Cartesian coordinates x, y, z of the rotation angular velocity. The combine accelerometer and gyroscope information is calculated to obtain the current bicycle attitude and forward momentum. The forward momentum includes gravity acceleration and rotation angular velocity. The bicycle attitude includes the bicycle side leaning angle, deviation of the traveling path and force acceleration angle. The gyroscope itself will produce drift caused by angular measurement cumulative error, need to use magnetometer to eliminate this error. With this information, the rider can analyze the data, improve the riding posture or the exercising targets

The GPS module 18 is capable of producing a position coordinates of the bicycle position and the corresponding time stamp that can be recorded in the memory device 13 or the same can be transmitted outbound via the wireless transmission module 16.

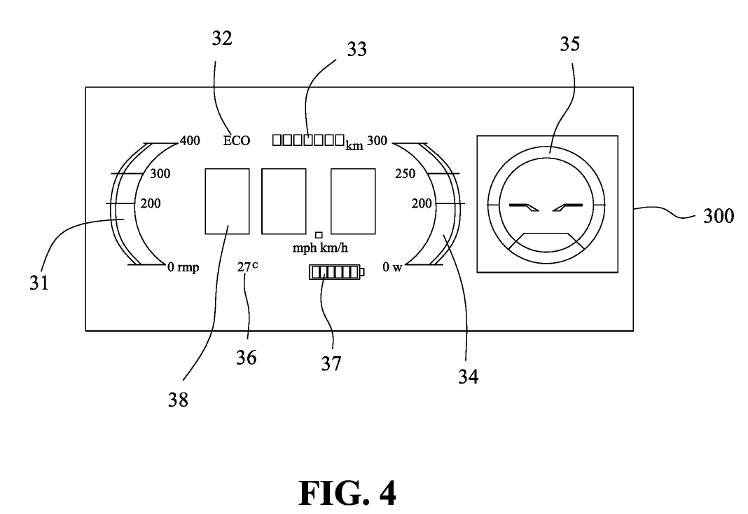

As best illustrated in FIGS. 3 and 4, the data transmitted outbound via the wireless transmission module can be displayed over the display screen of the smart phone 300 after execution by the software of the smart phone 300. The data may include rotation circles 31 of the bicycle wheel, the driving mode 32, an odometer 33, a level 35, a motor temperature 36, a battery capacity 37 and the pedaling speed of the bicycle 38. The smart phone can be ones we use presently, but should not be limited only thereto.

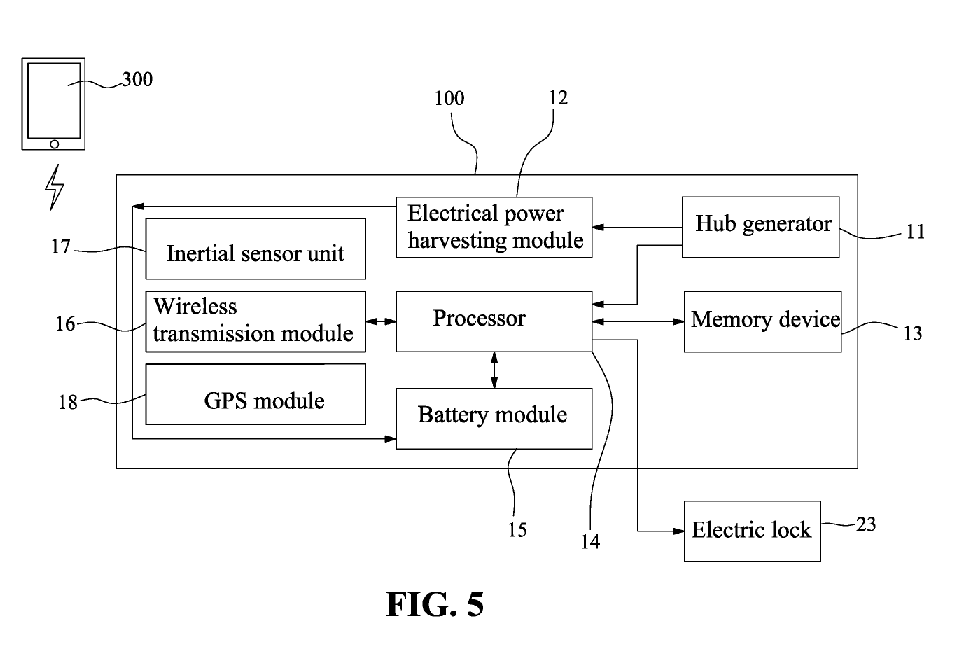

FIG. 5 is a block diagram representing a cycling record system according to a third embodiment of the present invention, the third embodiment is similar to the second embodiment, except that the third embodiment further includes an electric lock 23 mounted on the bicycle frame and is coupled electrically with the processor 14 in order to provide some features, like self protection effects. Once the electric lock 23 is activated, a particular part extends outwardly from the lock body, but should not be limited only thereto. When the electric lock 23 is integrated with the inertial sensor unit 17, the wireless transmission module 16 and the GPS module 18, the following features are provided.

Firstly, in case the bicycle installed with the cycling record system 100 of the present invention is shifted or moved abnormally, the accelerometer may detect the shifting movement or displacement of bicycle such that the processor 14 may transmit a warning signal via the wireless transmission module 16 to the owner's smart phone 300, informing whether it is a theft or not, or the GPS module 18 may generate a position coordinate of the bicycle to the owner to confirm if the bicycle is still at its initial position or the newly generated position coordinate may assist the owner to retrieve his lost bicycle.

Secondly, during the cycling operation, the power generated due to rotation of the bicycle wheel provides sufficient electricity of operation of the entire elements of the cycling record system of the present invention, wherein the wireless transmission module 16 and the owner's smart phone 300 are paired interactively to check if the riding person is the true owner of the bicycle. If the checking goes abnormal, the processor 14 may activate the electric lock 23 such that the particular part is extended outward from the bicycle frame into the bicycle wheel to stop rotation of the bicycle wheel, thereby preventing further riding of the bicycle.

One distinct aspect of the present invention resides in that the hub generator 11 produces low voltage, when the wheel is pedaled, thereby eliminating the rider to exert heavy burden and facilitating an ease riding of the bicycle. Under this condition, no high voltage or power is required which is generally used for lighting or the execution performance. In other words, the cycling record system of the present invention is simple in structure so that the hug generator can be integrated into the hub of the bicycle wheel such that the recording data system of the present invention cannot be dismantled easily from the bicycle frame, thereby facilitating the use of the cycling record system of the present invention. Moreover, in case the recorded data are required to be analyzed, they can be visible from the owner's smart phone or the information carrier. Since the hub generator is integrated into the hub of the bicycle wheel, no battery holding seat or other connection wire will be exposed from the bicycle frame, providing a neat and tidy appearance of the bicycle. Because the power harvesting module 12 is coupled electrically with the hub generator 11 and the battery module 15 such that the power harvesting module rectifies and boosts a voltage generated by the hub generator in order to recharge the battery module 15 continuously, thereby permanently allowing the processor to process the signals to write the data in the memory device 13 or transmitting the data outbound.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A cycling record system for a bicycle, comprising:
a hub generator;
a power harvesting module;
a memory device;
a processor;
a battery module; and
a wireless transmission module;
wherein, said hub generator is installed within a hub of a bicycle wheel, said processor is coupled electrically with said hub generator, said battery module is coupled electrically with said memory device and said wireless transmission module for supplying power thereto such that said process is capable of receiving and processing signals from said hub generator and converting into data consisting of speed rate and traveling distance of the bicycle so that said data can be recorded in said memory device or transmitted outbound via said wireless transmission module;
wherein, said power harvesting module is coupled electrically with said hub generator and said battery module such that said power harvesting module rectifies and boosts a voltage generated by the hub generator in order to recharge said battery module continuously, thereby permanently allowing said processor to process said signals to write data in said memory device or transmitting said data outbound.

2. The cycling record system according to claim 1, wherein said processor includes a Hall element for detecting a magnetic field and its intensity of the hub generator so as to obtain said speed rate and said traveling distance of the bicycle wheel.

3. The cycling record system according to claim 1, wherein said processor processes and obtains said speed rate and said traveling distance of the bicycle wheel by means of detecting a voltage phase change of said hub generator.

4. The cycling record system according to claim 2, further comprising an inertial sensor unit coupled to said processor, said inertial sensor unit consisting of an accelerometer, a gyroscope and a magnetometer for enhancing a procession performance of said processor.

5. The cycling record system according to claim 1, further comprising a GPS (Global Positioning System) module coupled with said processor such that said processor can produce a position coordinates of the bicycle and transmits outbound via said wireless transmission module.

6. The cycling record system according to claim 1, further comprising an electric lock coupled electrically with said processor.
